(19) United States
(12) Patent Application Publication
(10) Pub. No.: US 2024/0097255 A1
(43) Pub. Date: Mar. 21, 2024

(54) BATTERY PACK PARTITIONING METHOD AND SYSTEM

(71) Applicant: Ford Global Technologies, LLC, Canton, MI (US)

(72) Inventors: Steve Droste, Canton, MI (US); Brock Dunlap, Dearborn, MI (US); Kevin A. Montgomery, Royal Oak, MI (US); Hari Krishna Addanki, Novi, MI (US)

(21) Appl. No.: 17/947,321

(22) Filed: Sep. 19, 2022

(51) Int. Cl. H01M 50/242; B60L 3/00; H01M 50/249; H01M 50/289

(52) U.S. Cl. CPC H01M 50/242; B60L 3/0046; H01M 50/249; H01M 50/289; H01M 2200/10; H01M 2220/20

(57) ABSTRACT

A traction battery pack partitioning method includes providing a battery pack having an enclosure that houses at least a first battery array and a second battery array within an interior area, and, in response to thermal energy released from at least one battery cell in the first battery array, expanding a material to partition the interior area into a first subarea that houses the first battery area and a second subarea that houses the second battery array.

### TECHNICAL FIELD

This disclosure relates generally to partitioning an interior area of a traction battery pack.

### BACKGROUND

A traction battery pack of an electrified vehicle can include groups of battery cells arranged in one or more battery arrays. From time to time, pressure and thermal energy within one or more of the battery cells can increase. In response, gases and debris can be released from the one or more battery cells.

### SUMMARY

In some aspects, the techniques described herein relate to a traction battery pack partitioning method, including: providing a battery pack having an enclosure that houses at least a first battery array and a second battery array within an interior area; and in response to thermal energy released from at least one battery cell in the first battery array, expanding a material to partition the interior area into a first subarea that houses the first battery area and a second subarea that houses the second battery array.

In some aspects, the techniques described herein relate to a method, wherein the first subarea is fluidly isolated from the second subarea.

In some aspects, the techniques described herein relate to a method, wherein the material is an intumescent.

In some aspects, the techniques described herein relate to a method, wherein the material is a thermally-activated material.

In some aspects, the techniques described herein relate to a method, further including venting gases from the first subarea without the gases passing through the second subarea.

In some aspects, the techniques described herein relate to a method, wherein the expanding of the material is activated by thermal energy.

In some aspects, the techniques described herein relate to a method, further including expanding the material against a crossmember of the battery pack to create a barrier that partitions the interior area into the first subarea and the second subarea.

In some aspects, the techniques described herein relate to a method, wherein the material is secured to a cover of the enclosure prior to the expanding.

In some aspects, the techniques described herein relate to a method, wherein the battery pack is a battery pack of an electrified vehicle.

In some aspects, the techniques described herein relate to a battery pack partitioning system, including: an enclosure of a traction battery pack, the enclosure having an interior area; a first battery array housed within the interior area, the first battery array including a plurality of first battery cells; a second battery array housed within the interior area, the second battery array including a plurality of second battery cells; and a material that expands in response to thermal energy released from at least one of the first battery cells, when expanded, the material partitions the interior area into a first subarea that houses the first battery array and a second subarea that houses the second battery array.

In some aspects, the techniques described herein relate to a system, further including a first enclosure vent and a second enclosure vent, the first enclosure vent configured to vent the first subarea to an area outside the enclosure, the second enclosure vent configured to vent the second subarea to an area outside the enclosure.

In some aspects, the techniques described herein relate to a system, further including a crossmember within the interior area and disposed between the first and second battery arrays, the material expanding against the crossmember to partition the interior area in the first and second subarea.

In some aspects, the techniques described herein relate to a system, wherein the material is secured to a cover of the enclosure.

In some aspects, the techniques described herein relate to a system, wherein the material is an intumescent material.

In some aspects, the techniques described herein relate to a system, wherein the material is adhesively secured to the enclosure.

In some aspects, the techniques described herein relate to a system, wherein the material is mechanically fastened to the enclosure.

In some aspects, the techniques described herein relate to a system, wherein the material includes an expandable foam.

In some aspects, the techniques described herein relate to a system, wherein the first subarea is fluidly isolated from the second subarea.

In some aspects, the techniques described herein relate to a system, wherein the traction battery pack is a traction battery pack of an electrified vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle having a traction battery pack with a plurality of battery cells arranged in battery arrays and housed within an enclosure.

FIG. 2 illustrates a partially expanded view of the traction battery pack of FIG. 1 according to an exemplary embodiment of the present disclosure.

FIG. 3 illustrates a bottom view of an enclosure cover from the traction battery pack of FIG. 2.

FIG. 4 illustrates a section view taken a line 4-4 in FIG. 2 when the traction battery pack is assembled and no battery cells of the traction battery pack are experiencing a thermal event.

FIG. 5 illustrates a section view of FIG. 4 during a thermal event when gases and debris are released from one or more battery cells.

### DETAILED DESCRIPTION

This disclosure details exemplary methods and systems of partitioning a traction battery pack during a thermal event. Partitioning can help to confine gases and debris released from one or more battery cells in one of the battery arrays to an area of the traction battery pack. The released gases and debris can then be vented to a position outside the traction battery pack without raising thermal energy levels of the battery cells in other battery arrays of the traction battery pack.

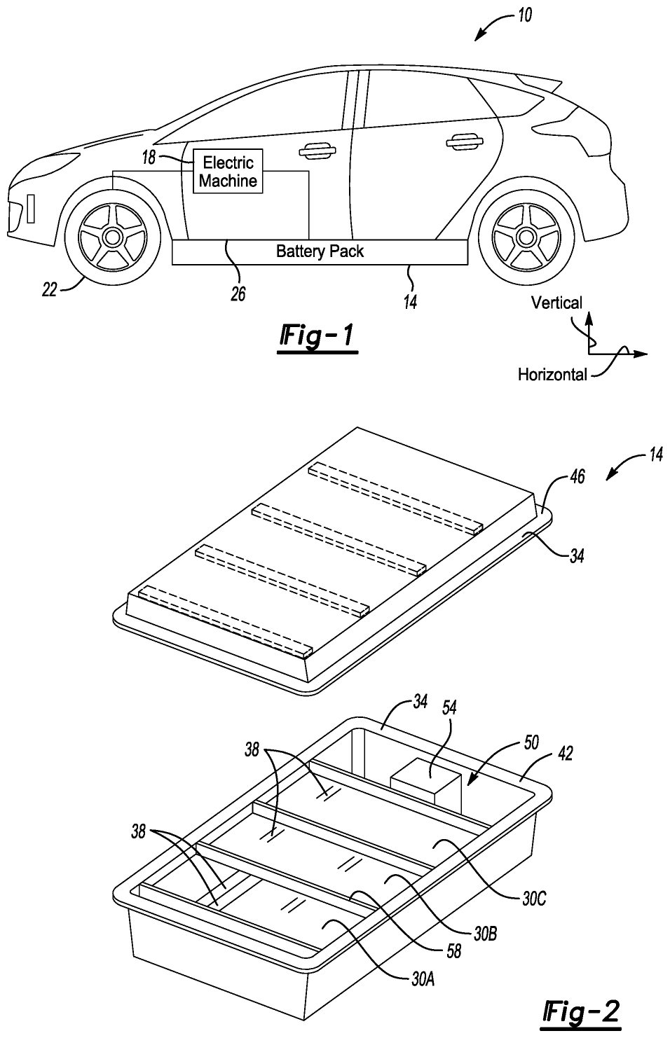

With reference to FIG. 1, an electrified vehicle 10 includes a traction battery pack 14, an electric machine 18, and wheels 22. The battery pack 14 powers an electric machine 18, which converts electric power to torque to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

Referring to FIG. 2 with continuing reference to FIG. 1, the battery pack 14 includes a first, a second, and a third battery array 30A-30C housed within an enclosure 34. The battery arrays 30A-30C are each provided by a group of individual battery cells 38 arranged in a row.

The enclosure 34, in this example, includes a tray 42 and a cover 46. The cover 46 can be secured to the tray 42 to contain the battery arrays 30A-30C within an interior area 50. Other structures, such as control modules, busbar modules, etc. can be housed within the interior area. An example module 54 is shown in schematic form in FIG. 2. Also, while three battery arrays 30A-30C are shown, other numbers of battery arrays 30A-30C could be used in other examples.

Within the interior area 50, crossmembers 58 are disposed between each of the battery arrays 30A-30C. The crossmembers 58 can enhance the structural integrity of the battery pack 14.

In an embodiment, the battery cells 38 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 38 can increase. The pressure and thermal energy increase can be due to an overcharge condition, for example. The pressure and thermal energy increase can cause the associated the battery cell 38 to rupture and release gas from within an interior of the associated battery cell 38. The gases released from the battery cell 38 can include debris. The gases and debris can be release from the associated battery cell 38 through a designated vent, such as a membrane that yields in response to increased pressure, or through a ruptured area of the associated battery cell 38.

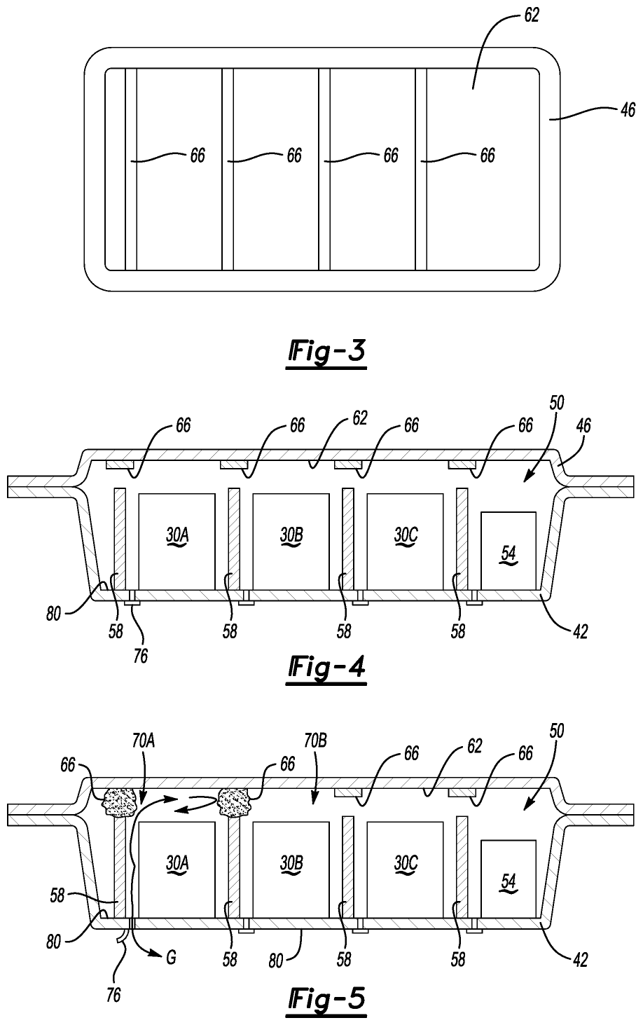

With reference now to FIG. 3-5 and continued reference to FIG. 2, an underside 62 of the cover 46 extends over the crossmembers 58 and battery arrays 30A-30C. Strips 66 of a thermally-responsive material are secured to an underside of the cover 46. The strips 66 are each aligned with a respective one of the crossmembers 58. The strips 66 can be intumescent materials. In particular, the strips 66 can be an expandable foam. Other thermally activated materials could be utilized as the strips 66 in other examples.

The strips 66 of material can be secured utilizing an adhesive, for example. In another example, the strips 66 of material are secured to the cover 46, or another area of the battery pack 14, using a mechanical fastener, such as a rivet.

Although shown as strips 66, the material could have other forms. For example, a sheet of thermally responsive material could line the entire cover 46 in areas that interface with the interior area 50.

The strips 66 expand in response to thermal energy levels exceeding a threshold level. During ordinary operation when none of the battery cells 38 are experiencing a thermal event and thermal energy levels within the interior area 50 are not sufficient to activate the strips 66, the strips 66 of material are secured to the cover 46 in an unexpanded state.

As shown in connection with FIG. 5, gases and debris G released from one of the battery cells 38 in the first battery array 30A can increase thermal energy levels in regions of the interior area 50 adjacent the first battery array 30A. The strips 66 nearest to the first battery array 30A then expand from the position of FIG. 4 to the position of FIG. 5 in response to the increase in thermal energy.

The strips 66 expand vertically downward to contact a respective one of the crossmembers 58 to establish and partition the interior area 50 into a first subarea 70A and a second subarea 70B. The strips 66, when expanded, create a barrier that partitions the interior area 50 into the first subarea 70A and the second subarea 70B. Vertical, for purposes of this disclosure is with reference to ground and a general orientation of the vehicle 10 of FIG. 1 during operation.

Expanding the strips 66 to partition the interior area 50 fluidly isolates the first subarea 70A from the second subarea 70B. In other examples, the strips 66 could instead or additionally expand against structures other than the crossmembers 58.

The first battery array 30A, which contains the battery cell 38 that is releasing the gas and debris, resides in the first subarea 70A. When the first subarea 70A is partitioned from the second subarea 70B, the gases and debris G from the cells 38 of the first battery array 30A are contained within the first subarea 70A and do not enter the second subarea 70B. Permitting the gases to move into the second subarea 70B could increase thermal energy levels in the second battery array 30B or the third battery array 30C leading to a thermal event associated with the second battery array 30B or the third battery array 30C. Permitting the debris to move into the second subarea 70B could establish a conductive paths between the battery arrays 30A-30C.

In this example, pressure within the first subarea 70A increases as the battery cell 38 of the first battery array 30A continues to release the gas and debris G. The pressure increase eventually causes an enclosure vent 76 in a floor 80 of the tray 42 to open, which permits the gases and debris G to flow from the first subarea 70A to an area outside the battery pack 14. The gases and debris G move to an area outside the battery pack 14 without passing into the second subarea 70B.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack partitioning method, comprising:
providing a battery pack having an enclosure that houses at least a first battery array and a second battery array within an interior area; and
in response to thermal energy released from at least one battery cell in the first battery array, expanding a material to partition the interior area into a first subarea that houses the first battery area and a second subarea that houses the second battery array.

2. The method of claim 1, wherein the first subarea is fluidly isolated from the second subarea.

3. The method of claim 1, wherein the material is an intumescent.

4. The method of claim 1, wherein the material is a thermally-activated material.

5. The method of claim 1, further comprising venting gases from the first subarea without the gases passing through the second subarea.

6. The method of claim 1, wherein the expanding of the material is activated by thermal energy.

7. The method of claim 1, further comprising expanding the material against a crossmember of the battery pack to create a barrier that partitions the interior area into the first subarea and the second subarea.

8. The method of claim 1, wherein the material is secured to a cover of the enclosure prior to the expanding.

9. The method of claim 1, wherein the battery pack is a battery pack of an electrified vehicle.

10. A battery pack partitioning system, comprising:
an enclosure of a traction battery pack, the enclosure having an interior area;
a first battery array housed within the interior area, the first battery array including a plurality of first battery cells;
a second battery array housed within the interior area, the second battery array including a plurality of second battery cells; and
a material that expands in response to thermal energy released from at least one of the first battery cells, when expanded, the material partitions the interior area into a first subarea that houses the first battery array and a second subarea that houses the second battery array.

11. The system of claim 10, further comprising a first enclosure vent and a second enclosure vent, the first enclosure vent configured to vent the first subarea to an area outside the enclosure, the second enclosure vent configured to vent the second subarea to an area outside the enclosure.

12. The system of claim 10, further comprising a crossmember within the interior area and disposed between the first and second battery arrays, the material expanding against the crossmember to partition the interior area in the first and second subarea.

13. The system of claim 11, wherein the material is secured to a cover of the enclosure.

14. The system of claim 10, wherein the material is an intumescent material.

15. The system of claim 10, wherein the material is adhesively secured to the enclosure.

16. The system of claim 10, wherein the material is mechanically fastened to the enclosure.

17. The system of claim 10, wherein the material comprises an expandable foam.

18. The system of claim 10, wherein the first subarea is fluidly isolated from the second subarea.

19. The system of claim 10, wherein the traction battery pack is a traction battery pack of an electrified vehicle.
